(19) United States
(12) Patent Application Publication
(10) Pub. No.: US 2005/0084035 A1
(43) Pub. Date: Apr. 21, 2005

(54) Apparatus and method for transmitting and receiving a pilot signal in a communication system using a multi-carrier modulation scheme

(75) Inventors: Eung-Sun Kim, Suwon-si (KR); Jong-Hyeuk Lee, Seongnam-si (KR); Ho-Jin Kim, Seoul (KR); Sang-Boh Yun, Seongnam-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/932,854

(22) Filed: Sep. 2, 2004

(30) Foreign Application Priority Data
Sep. 2, 2003 (KR) 2003-61245

(51) Int. Cl. H04L 27/04

(52) U.S. Cl. 375/295

(57) ABSTRACT

In an MCM communication system in which one frame includes at least one pilot symbol of a predetermined length and at least one data symbol of the predetermined length, to transmit the pilot symbol for time synchronization and frequency synchronization, a first pilot sequence of a length shorter than the predetermined length is generated, and a second pilot sequence of a length shorter than the predetermined length is generated. Here, the second pilot sequence is different from the first pilot sequence. The first and second pilot sequences are repeated a predetermined number of times. The pilot symbol is generated by combining the repeated first and second pilot sequences, and then transmitted.

### PRIORITY

This application claims priority under 35 U.S.C. § 119 to an application entitled “Apparatus and Method for Transmitting/Receiving Pilot in a Communication System Using Multi-Carrier Modulation Scheme” filed in the Korean Intellectual Property Office on Sep. 2, 2003 and assigned Ser. No. 2003-61245, the contents of which are incorporated herein by reference.

### BACKGROUND OF THE INVENTION

1. Field of the Invention

The present invention relates generally to a communication system using a multi-carrier modulation scheme, and in particular, to an apparatus and method for transmitting and receiving a pilot signal to acquire time synchronization and frequency synchronization.

2. Description of the Related Art

As mobile communication technology develops, user demands for transmitting and receiving more data at higher rates increase. High-speed transmission of data on a radio channel in a mobile communication system leads to a high BER (Bit Error Rate) as a result of multi-path fading and Doppler spread. Therefore, there is a pressing need for a wireless connection scheme suitable for radio channels.

Commonly, a spread spectrum modulation scheme is widely used due to its advantages of relative low transmit power and low probability of detection. The spread spectrum modulation scheme is branched into a direct sequence spread spectrum (DSSS) scheme and a frequency hopping spread spectrum (FHSS) scheme. The DSSS scheme actively copes with multi-path fading by using a rake receiver, relying on the path diversity of a channel. While the DSSS scheme is efficient at a data rate up to 10 Mbps, inter-chip interference increases at or above 10 Mbps. As a result, hardware complexity rapidly increases and multi-user interference limits the number of users that a base station (BS) can accommodate, i.e., system capacity.

The FHSS scheme transmits data through frequency hopping using a random sequence, thereby reducing the effects of multi-path interference and narrow band impulse noise. Accurate synchronization between a transmitter and a receiver is very important in the FSS scheme, but it is difficult in high-speed data transmission.

Recently, OFDM (Orthogonal Frequency Division Multiplexing) has emerged as a feasible wireless connection scheme for high-speed data transmission. OFDM, which is useful for high-speed data transmission on wired and wireless channels, transmits data on multiple carriers. It is a special case of MCM (Multi-Carrier Modulation) in which an input serial symbol sequence is converted to parallel symbol sequences and modulated to multiple orthogonal sub-carriers, prior to transmission.

The first MCM systems appeared in the late 1950's for military high frequency (HF) radio communication, and OFDM with overlapping orthogonal sub-carriers was initially developed in the 1970's. In view of orthogonal modulation between multiple carriers, OFDM has limitations in actual implementation for systems. In 1971, Weinstein, et al. proposed an OFDM scheme that utilizes DFT (Discrete Fourier Transform) in parallel data transmission as an efficient modulation/demodulation process, which was a driving force behind the development of OFDM. Also, the introduction of a guard interval and a cyclic prefix as the guard interval further mitigates adverse effects of multi-path propagation and delay spread on systems. As a result, OFDM has widely been used in digital data communications such as digital audio broadcasting (DAB), digital TV broadcasting, wireless local area network (WLAN), and wireless asynchronous transfer mode (WATM).

Although hardware complexity was an obstacle to wide use of OFDM, recent advances in digital signal processing technology including FFT and IFFT enable OFDM to be implemented. OFDM, similar to FDM (Frequency Division Multiplexing), boasts of optimum transmission efficiency in high-speed data transmission because it transmits data on sub-carriers, maintaining orthogonality among them. The optimum transmission efficiency is further attributed to good frequency use efficiency and robustness against multi-path fading in OFDM. More specifically, overlapping frequency spectrums lead to efficient frequency use and robustness against frequency selective fading and multi-path fading. OFDM reduces effects of the ISI by using guard intervals and enables design of a simple equalizer hardware structure. Further, because OFDM is robust against impulse noise, it is increasingly popular in communication systems.

FIG. 1 schematically illustrates a frame structure in a conventional communication system using the MCM scheme (hereinafter, referred to as a multi-carrier communication system). Referring to FIG. 1, a frame includes a plurality of pilot symbol areas and a plurality of data symbol areas in the multi-carrier communication system. The pilot symbol areas deliver pilot symbols by which time synchronization and frequency synchronization are acquired, channel estimation is performed, and a CQI (Channel Quality Information) is measured. Each pilot symbol is formed out of a predetermined pilot sequence. The data symbol areas deliver data symbols including information data. If N denotes a frame length and Nₚ denotes the total length of the pilot symbols. Then the total length of the data symbols in the frame is N_{d} (=N-N_{P}).

Many methods have been proposed for time synchronization and frequency synchronization in the multi-carrier communication system. For example, these include methods proposed by Schmidl and Minn (See Timothy M. Schmidl, and Donald C. Cox, “Robust Frequency and Timing Synchronization for OFDM,” IEEE Transactions on Communications, Vol. 45, No. 12, December 1997, and H. Minn, M. Zeng, and V. K. Bharagava, “On Timing Offset Estimation for OFDM Systems,” IEEE Communications Letter, Vol. 4, No. 7, July 2000), the use of a cyclic prefix, and a method based on IEEE (Institute of Electrical and Electronics Engineers) 802.11a. For notational simplicity, an OFDM communication system is taken as an example of the multi-carrier communication system.

FIG. 2 illustrates a pilot symbol structure according to Schmidl's method. It is assumed herein that one OFDM symbol is N (samples) in length. Therefore, one pilot symbol and one data symbol each have N samples. The same assumption is also applied to Minn's method, the cyclic prefix method, and the IEEE 802.11a-based method.

Referring to FIG. 2, Schmidl forms one pilot symbol using two equal pilot sequences. In other words, one pilot symbol is created by combining two pilot sequences A_{Sch}, each having N/2 samples, expressed by
P=[AA] (1)
where P denotes a pilot symbol and A denotes N/2 samples.

According to the Schmidl's method, time synchronization is determined by

$$\tilde{T} = \frac{{\vert {P}_{1} ( d ) \vert}^{2}}{{( {R}_{1} ( d ) )}^{2}} \qquad ( 2 )$$

where \tilde{T} denotes estimated time synchronization, that is, an estimated symbol timing or frame timing. \tilde{T} that maximizes

$$\frac{{\vert {P}_{1} ( d ) \vert}^{2}}{{( {R}_{1} ( d ) )}^{2}}$$

in a corresponding accumulation period is detected as a symbol timing or a frame timing. The symbol timing indicates the start point of a symbol and the frame timing indicates the start point of a frame. Because the pilot sequence A_{Sch} occurs twice in one frame, the accumulation period is N/2 samples.

In equation (2),

$${P}_{1} ( d ) = {\sum }_{k = 0}^{\frac{N}{2} - 1} {r}^{*} ( d + k ) r ( d + k + \frac{N}{2} ) , \\ {R}_{1} ( d ) = {\sum }_{k = 0}^{\frac{N}{2} - 1} {\vert r ( d + k + \frac{N}{2} ) \vert}^{2} ,$$

and r(d) denotes a received signal. P(d) is an accumulation value of correlations between a (d+k)th sample and a (d+k+N/2)th sample in the accumulation period, and R₁(d) is the average power of the accumulation period. In this manner, symbol timing and frame timing are detected, that is, symbol synchronization and frame synchronization are acquired. Frequency synchronization is acquired by the symbol synchronization and frame synchronization.

The frequency synchronization in the Schmidl's method will be described in more detail herein below.

A frequency offset is denoted by 5f. Then, the received signal is given as

$$r ( {nT}_{s} ) = S ( {nT}_{s} - T ) exp ( j2 π \cdot δ f \cdot n \cdot {T}_{s} ) + g ( n ) \\ = S ( {nT}_{s} - T ) exp ( j2 π \cdot δ f \frac{n}{N \cdot Δ f} ) + g ( n ) \qquad ( 3 )$$

where r(nTₛ) is the received signal, s(t) is a transmitted signal, Tₛ is a sampling period, Δf is a sub-carrier spacing, and g(n) is AWGN (Additive White Gaussian Noise).

Assuming that a timing offset is accurately estimated in the time synchronization, that is, T is accurately estimated, P₁(T) is determined by

$${P}_{1} ( T ) = {\sum }_{k = 0}^{\frac{N}{2} - 1} {r}^{*} ( T + k ) r ( T + k + \frac{N}{2} ) \\ = {\sum }_{k = 0}^{\frac{N}{2} - 1} {S}^{*} ( k ) exp ( - j2 π \cdot δ f \frac{k}{N \cdot Δ f} ) S ( k + \frac{N}{2} ) exp ( j2 π \cdot δ f \frac{k + \frac{N}{2}}{N \cdot Δ f} ) \\ = {\sum }_{k = 0}^{\frac{N}{2} - 1} {S}^{*} ( k ) S ( k + \frac{N}{2} ) exp ( j2 π \cdot δ f \frac{1}{2 \cdot Δ f} ) \qquad ( 4 )$$

Under the same assumption, Equation (4) is developed to

$$< {P}_{1} ( T ) = 2 π \cdot δ f \cdot \frac{1}{2 \cdot Δ f} \qquad ( 5 )$$

where ∠P₁(T) is the phase of P₁(T). Therefore, the frequency offset can be estimated using Equation (5), expressed as

$$δ f = \frac{Δ f}{π} < {P}_{1} ( T ) \qquad ( 6 )$$

Considering the 2π ambiguity of the phase, the condition that |∠P₁(T)|<π must be satisfied. In the Schmidl's method, therefore, a frequency acquisition range for the frequency synchronization is
|δf|=Δf (7)

As noted from Equation (7), the frequency acquisition range is one sub-carrier in the Schmidl's method. It follows that a frequency offset exceeding one sub-carrier cannot be detected, limiting the frequency synchronization acquisition.

FIG. 3 schematically illustrates a pilot symbol structure according to Minn's method. As described above referring to FIG. 2, it is assumed that one OFDM symbol has N samples. Therefore, one pilot symbol has N samples in the OFDM communication system.

Referring to FIG. 3, Minn uses a pilot symbol having four same pilot sequences. Four pilot sequences A_{Minn} each having N/4 samples form one pilot symbol. A_{Minn} occurs twice with the same phase, and then twice with an inverse phase. Therefore,
P=[AA-A-A] (8)
where P denotes a pilot symbol and A denotes N/4 samples.

According to Minn's method, time synchronization is determined by

$$\tilde{T} = \frac{{\vert {P}_{2} ( d ) \vert}^{2}}{{( {R}_{2} ( d ) )}^{2}} \qquad ( 9 )$$

where \tilde{T} denotes estimated time synchronization, that is, an estimated symbol timing or frame timing. \tilde{T} that maximizes

$$\frac{{\vert {P}_{2} ( d ) \vert}^{2}}{{( {R}_{2} ( d ) )}^{2}}$$

in a corresponding accumulation period is detected as a symbol timing or a frame timing. The symbol timing indicates the start point of a symbol and the frame timing indicates the start point of a frame. Because the pilot sequence A_{Minn} occurs four times in one frame, the accumulation period is N/4 samples.

In Equation (9),

$${P}_{2} ( d ) = {\sum }_{m = 0}^{1} {\sum }_{k = 0}^{\frac{N}{4} - 1} r * ( d + \frac{N}{2} m + k ) r ( d + \frac{N}{2} m + k + \frac{N}{4} ) , \\ {R}_{1} ( d ) = {\sum }_{m = 0}^{1} {\sum }_{k = 0}^{\frac{N}{4} - 1} {\vert r ( d + \frac{N}{2} m + k + \frac{N}{4} ) \vert}^{2} ,$$

and r(d) denotes a received signal. P₂(d) is an accumulation value of correlations between a (d+k)th sample and a (d+k+N/4)th sample in the accumulation period, and R₂(d) is the average power of the accumulation period. m in P₂(d) is a variable representing a set of plot sequences in the pilot symbol. If m=0, it implies that the first two pilot sequences of the pilot symbol are correlated. If m=1, the last two pilot sequences of the pilot symbol are correlated.

Accordingly, symbol timing and frame timing are detected, that is, symbol synchronization and frame synchronization are acquired. Frequency synchronization is acquired from the symbol synchronization and frame synchronization.

The frequency synchronization in Minn's method will be described in more detail herein below.

Again, a frequency offset is denoted as δf. Assuming that a timing offset is accurately estimated in the time synchronization, that is, T is accurately estimated, P₂(T) is determined by

$$\begin{matrix}{P}_{2} ( T ) = {\sum }_{m = 0}^{1} {\sum }_{k = 0}^{\frac{N}{4} - 1} {S}^{*} ( k + \frac{N}{2} m + ) \\ S ( k + \frac{N}{2} m + \frac{N}{4} ) exp ( j2 π \cdot δ f \frac{1}{4 \cdot Δ f} )\end{matrix} \qquad ( 10 )$$

Under the same assumption, Equation (10) is developed to

$$∠ {P}_{2} ( T ) = 2 π \cdot δ f \cdot \frac{1}{4 \cdot Δ f} \qquad ( 11 )$$

where ∠P₂(T) is the phase of P₂(T). Hence, the frequency offset can be estimated using equation (11), expressed as

$$δ f = \frac{2 \cdot Δ f}{π} ∠ {P}_{2} ( T ) \qquad ( 12 )$$

Considering the 2π ambiguity of the phase, the condition that |∠P₂(T)|<π must be satisfied. In Minn's method, therefore, a frequency acquisition range for the frequency synchronization is
|δf|=2·Δf (13)

As noted from Equation (13), the frequency acquisition range is two sub-carriers in Minn's method. It follows that a frequency offset exceeding two sub-carriers cannot be detected, limiting the frequency synchronization acquisition. While the frequency acquisition range is wider than in Schmidl's method, it also limits accurate frequency offset estimation in real radio communications.

FIG. 4 schematically illustrates an OFDM symbol structure according to the cyclic prefix method. The same assumption as used for FIGS. 2 and 3 is also applied to FIG. 4, i.e., one OFDM symbol length is N samples. The length of a cyclic prefix is assumed to be N_{cp} samples. The OFDM communication system inserts a guard interval to eliminate interference between the previous OFDM symbol and the current OFDM symbol. The guard interval may be a cyclic prefix or a cyclic postfix. Predetermined last samples of an OFDM symbol are copied and inserted into an effective OFDM symbol. This is called a cyclic prefix. Predetermined first samples of an OFDM symbol are copied and inserted into an effective OFDM symbol. This is called a cyclic postfix. Therefore, the cyclic prefix is an actual guard interval. For conciseness, the cyclic prefix is used interchangeably with the guard interval.

Referring to FIG. 4, last N_{cp} samples of an OFDM symbol are copied and inserted before the OFDM symbol. A correlation function G(n) in the cyclic prefix method is given as

$$G ( n ) = \frac{1}{{N}_{cp}} {\sum }_{k = 0}^{{N}_{cp} - 1} r ( n - k ) r ( n - k - N ) \qquad ( 14 )$$

When G(n) is a maximum value, the current sample matches to the last sample of the OFDM symbol. Therefore, a symbol timing delay, that is, symbol or framing timing is determined by
\tilde{T}=arg max |G(n)| (15)
a frequency offset is

$$δ \tilde{f} = \frac{1}{2 π} ∠ G ( \tilde{T} ) \qquad ( 16 )$$

and a frequency acquisition range is

$$\vert δ f \vert = \frac{1}{2} \cdot Δ f \qquad ( 17 )$$

As noted from Equation (17), the frequency acquisition range is one half of a sub-carrier in the cyclic prefix method. It follows that a frequency offset exceeding one half of a sub-carrier cannot be detected, limiting the frequency synchronization acquisition.

While the frequency acquisition range is much narrower than in Schmidl's method and Minn's method, the cyclic prefix method has limitations in accurate frequency offset estimation. Further, in the cyclic prefix method, symbol timing can be acquired but frame timing acquisition is very difficult. As a result, synchronization acquisition is difficult on the whole.

FIG. 5 schematically illustrates a pilot symbol structure based on IEEE 802.11a. As described referring to FIGS. 2 and 3, it is assumed that one OFDM symbol has N samples and thus one pilot symbol has N samples in the OFDM communication system.

Referring to FIG. 4, a pilot symbol has four same pilot sequences according to IEEE. 802.11a. Four pilot sequences A_{802.11a} each having N/4 samples form one pilot symbol. A_{802.11a} occurs four times, as compared to Minn's method. Therefore,
P=[AAAA] (18)
where P denotes a pilot symbol and A denotes N/4 samples.

According to IEEE 802.11a, time synchronization is determined by

$$\tilde{T} = \frac{{\vert P ( d ) \vert}^{2}}{{( R ( d ) )}^{2}} \qquad ( 19 )$$

where \tilde{T} denotes estimated time synchronization, that is, an estimated symbol timing or frame timing. \tilde{T} that maximizes

$$\frac{{\vert P ( d ) \vert}^{2}}{{( R ( d ) )}^{2}}$$

in a corresponding accumulation period is detected as a symbol timing or a frame timing. The symbol timing indicates the start point of a symbol and the frame timing indicates the start point of a frame. Because the pilot sequence A_{802.11a} occurs four times in one frame, the accumulation period is N/4 samples.

In Equation (19),

$$P ( d ) = {\sum }_{m = 0}^{3} {\sum }_{k = 0}^{N / 4 - 1} {r}^{*} ( d + \frac{N}{4} m + k ) r ( d + \frac{N}{4} ( m + 1 ) + k ) , \\ R ( d ) = {\sum }_{k = 0}^{N - 1} {\vert r ( d + k ) \vert}^{2} ,$$

and r(d) denotes a received signal. P(d) is an accumulation value of correlations between a (d+k)th sample and a (d+k+N/4)th sample in the accumulation period, and R(d) is the average power of the accumulation period. If m=0 in P(d), it implies that the fourth pilot sequence copied for a cyclic prefix is correlated with the first of the four pilot sequences in the pilot symbol. If m=1, the first and second pilot sequences of the pilot symbol are correlated. If m=2, the second and third pilot sequences of the pilot symbol are correlated. If m=3, the third and fourth pilot sequences of the pilot symbol are correlated.

Accordingly, symbol timing and frame timing are detected, that is, symbol synchronization and frame synchronization are acquired. Frequency synchronization is acquired by the symbol synchronization and frame synchronization.

The frequency synchronization according to IEEE 802.11a will be described in more detail herein below.

Again, a frequency offset is denoted as δf. Assuming that a timing offset is accurately estimated in the time synchronization, that is, T is accurately estimated, P(T) is determined by

$$P ( T ) = {\sum }_{m = 0}^{1} {\sum }_{k = 0}^{N / 4 - 1} {S}^{*} ( k + \frac{N}{2} m + ) S ( k + \frac{N}{2} m + \frac{N}{4} ) exp ( j 2 π \cdot δ f \frac{1}{4 \cdot Δ f} ) \qquad ( 20 )$$

Under the same assumption, Equation (20) is developed to

$$∠ P ( T ) = 2 π \cdot δ f \cdot \frac{1}{4 \cdot Δ f} \qquad ( 21 )$$

where ∠P(T) is the phase of P(T). Therefore, the frequency offset can be estimated using equation (21), expressed as

$$δ f = \frac{2 \cdot Δ f}{π} < P ( T ) \qquad ( 22 )$$

Considering the 2π ambiguity of the phase, the condition that |∠P(T)|<π must be satisfied. According to IEEE 802.11a, therefore, a frequency acquisition range for the frequency synchronization is
|δf|=2·Δf (23)

As noted from Equation (23), the frequency acquisition range is two sub-carriers according to IEEE 802.11a. It follows that a frequency offset exceeding two sub-carriers cannot be detected, limiting the frequency synchronization acquisition. While the frequency acquisition range is wider than in Schmidl's method and Minn's method, it also limits accurate frequency offset estimation in real radio communications.

While the above-described Schmidl method, Minn method, and the IEEE 802.11a-based method enable acquisition of symbol timing, frame timing, and frequency synchronization, they offer limited frequency acquisition ranges, thereby making it impossible to acquire accurate frequency synchronization. The cyclic prefix method enables acquisition of symbol timing, but not framing timing. It also offers a limited frequency acquisition range, making it impossible to acquire accurate frequency synchronization. Therefore, there is a need for a method of acquiring timing synchronization and frequency synchronization with a less limited frequency acquisition range.

### SUMMARY OF THE INVENTION

An object of the present invention is to substantially solve at least the above problems and/or disadvantages and to provide at least the advantages as described below.

Accordingly, an object of the present invention is to provide an apparatus and method for transmitting and receiving a pilot signal to acquire time synchronization and frequency synchronization in an MCM communication system.

Another object of the present invention is to provide an apparatus and method for transmitting and receiving a pilot signal to minimize the limit of a frequency acquisition range in frequency synchronization in an MCM communication system.

The above objects are achieved by providing an apparatus and method for transmitting and receiving a pilot signal in a MCM communication system.

According to one aspect of the present invention, in an MCM communication system in which one frame has at least one pilot symbol of a predetermined length and at least one data symbol of the predetermined length, to transmit the pilot symbol by which time synchronization and frequency synchronization are acquired, a first pilot sequence of a length shorter than the predetermined length is generated, and a second pilot sequence of a length shorter than the predetermined length is generated. Here, the second pilot sequence is different from the first pilot sequence. The first and second pilot sequences are repeated a predetermined number of times. The pilot symbol is generated by combining the repeated first and second pilot sequences. Thereafter, the pilot symbol is transmitted.

According to another aspect of the present invention, in an MCM communication system in which one frame has at least one pilot symbol of a predetermined length and at least one data symbol of the predetermined length, in an apparatus for receiving the pilot symbol to acquire time synchronization and frequency synchronization, a time synchronization acquirer receives a pilot symbol having first and second pilot sequences repeated a predetermined number of times. The first and second pilot sequences have a length shorter than the predetermined length. The time synchronization acquirer acquires time synchronization with a transmitting apparatus. A frequency synchronization acquirer receives the pilot symbol, synchronizes with the transmitting apparatus according to the time synchronization acquired in time synchronization acquirer, and acquires frequency synchronization.

According to a further aspect of the present invention, in an MCM communication system in which predetermined N sub-carriers are used, N sub-carrier signals form a symbol, and one frame has at least one pilot symbol of a predetermined length and at least one data symbol of the predetermined length, in an apparatus for receiving the pilot symbol to acquire time synchronization and frequency synchronization, a time synchronization acquirer receives a pilot symbol having first and second pilot sequences repeated a predetermined number of times. The first and second pilot sequences have a length shorter than the predetermined length. The time synchronization acquirer acquires time synchronization with a transmitting apparatus. A frequency synchronization acquirer receives the pilot symbol, synchronizes to the transmitting apparatus according to the time synchronization acquired in time synchronization acquirer, and acquires frequency synchronization.

According to still another aspect of the present invention, in an MCM communication system in which one frame has at least one pilot symbol of a predetermined length and at least one data symbol of the predetermined length, to receive the pilot symbol for acquiring time synchronization and frequency synchronization, the pilot symbol is received which has first and second pilot sequences repeated a predetermined number of times. The first and second pilot sequences have a length shorter than the predetermined length. Then, time synchronization to a transmitting apparatus is acquired. The pilot symbol is received, timing is synchronized to the transmitting apparatus according to the time synchronization acquisition, and frequency synchronization is acquired.

According to yet another aspect of the present invention, in an MCM communication system in which one frame has at least one pilot symbol of a predetermined length and at least one data symbol of the predetermined length, to receive the pilot symbol for acquiring time synchronization and frequency synchronization, the pilot symbol is received which has first and second pilot sequences repeated a predetermined number of times. The first and second pilot sequences have a length shorter than the predetermined length. Then, time synchronization to a transmitting apparatus is acquired. The pilot symbol is received, timing is synchronized with the transmitting apparatus according to the time synchronization acquisition, and frequency synchronization is acquired.

### BRIEF DESCRIPTION OF THE DRAWINGS

The above and other objects, features, and advantages of the present invention will become more apparent from the following detailed description when taken in conjunction with the accompanying drawings in which:

FIG. 1 schematically illustrates a frame structure in a conventional multi-carrier communication system;

FIG. 2 schematically illustrates a pilot symbol structure according to Schmidl's method;

FIG. 3 schematically illustrates a pilot symbol structure according to Minn's method;

FIG. 4 schematically illustrates a pilot symbol structure according to a cyclic prefix method;

FIG. 5 schematically illustrates a pilot symbol structure according to IEEE 802.11a;

FIG. 6 schematically illustrates a pilot symbol structure according an embodiment of the present invention;

FIG. 7 is a block diagram of a pilot signal receiver to which the present invention is applied;

FIG. 8 is a graph illustrating time metrics in Schmidl's method, Minn's method, the IEEE 802.11a-based method, and a method of acquiring time synchronization and frequency synchronization according to the present invention, when the length of a cyclic prefix is 25% of an OFDM symbol length;

FIG. 9 is a graph illustrating time metrics in Schmidl's method, Minn's method, the IEEE 802.11a-based method, and the present invention, when the cyclic prefix length is 10% of the OFDM symbol length;

FIG. 10 is a graph illustrating mean channel power versus time delay;

FIG. 11 is a graph illustrating the mean of an estimated symbol timing offset in Schmidl's method, Minn's method, the IEEE 802.11a-based method, and the present invention, when a frequency offset is 3Δf;

FIG. 12 is a graph illustrating the MSE (Mean Square Error) of a symbol timing offset estimation error in Schmidl's method, Minn's method, the IEEE 802.11a-based method, and the present invention, when the frequency offset is 3Δf;

FIG. 13 is a graph illustrating the mean of an estimable frequency offset in Schmidl's method, Minn's method, IEEE 802.11a-based method, and the present invention, when the frequency offset is 3Δf; and

FIG. 14 is a graph illustrating the MSE of a frequency offset estimation error in the Schmidl method, the Minn method, the IEEE 802.11a-based method, and the present invention, when the frequency offset is 3Δf.

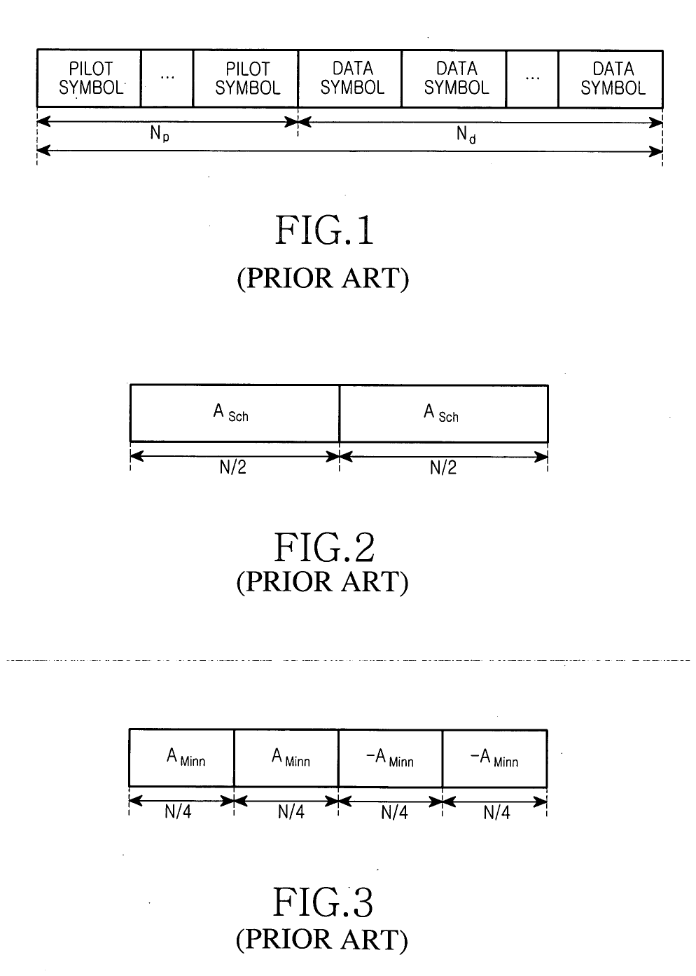

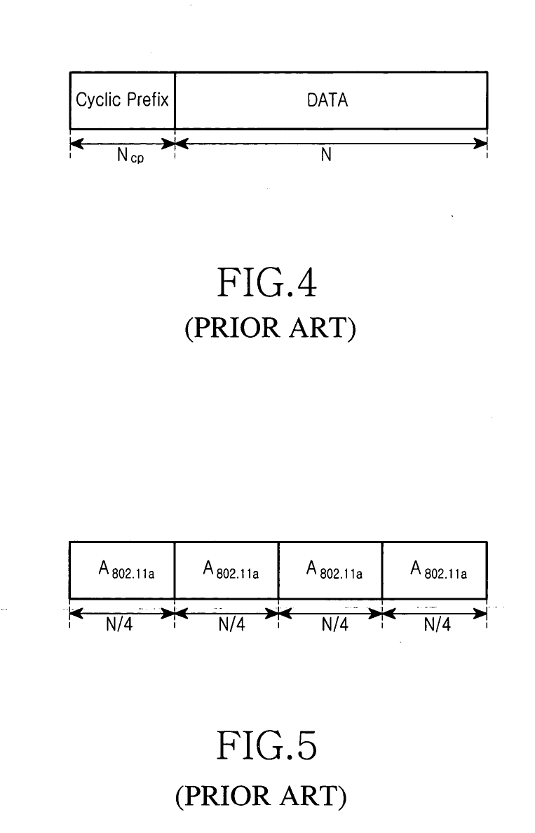

### DETAILED DESCRIPTION OF THE PREFERRED EMBODIMENT

Preferred embodiments of the present invention will be described in detail herein below with reference to the accompanying drawings. In the following description, well-known functions or constructions are not described in detail since they would obscure the invention in unnecessary detail.

The present invention provides a pilot signal transmitting and receiving method for acquiring time synchronization and frequency synchronization in a multi-carrier communication system. More specifically, the present invention enables acquisition of accurate frequency synchronization by widening a frequency acquisition range in frequency synchronization. For notational simplicity, the multi-carrier communication system will be described in the context of an OFDM communication system.

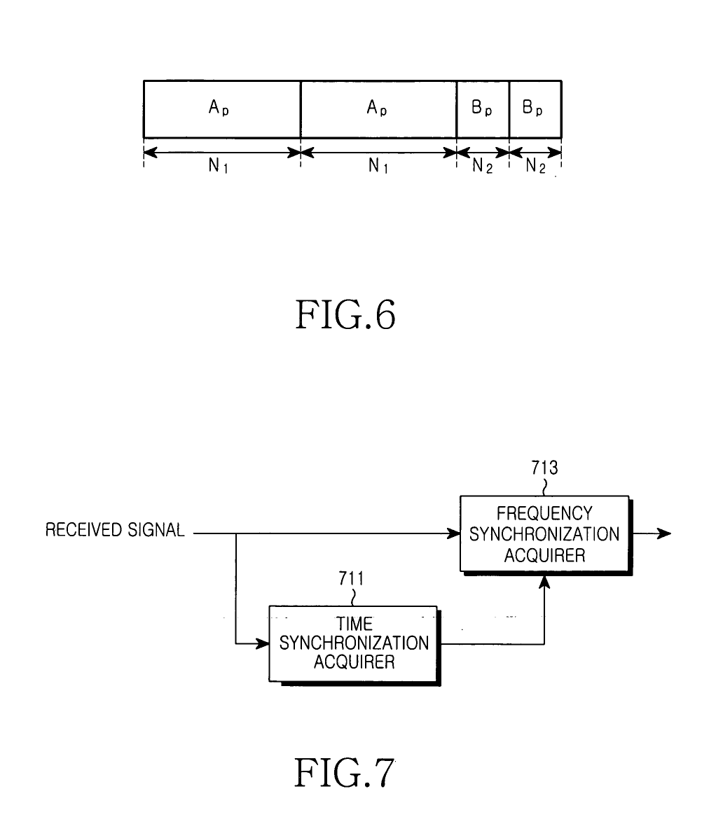

FIG. 6 schematically illustrates a pilot symbol structure according to an embodiment of the present invention. In the OFDM system, it is assumed that one OFDM symbol has N samples. Therefore, one pilot symbol and one data symbol have N samples, each.

Referring to FIG. 6, a pilot symbol including two different pilot sequences is used to acquire time synchronization and frequency synchronization according to the present invention. As illustrated, a first pilot sequence Aₚ of length N₁ occurs twice, followed by two occurrences of a second pilot sequence Bₚ of length N₂. N₁ and N₂ are in the relationship that
2×(N₁+N₂)=N (24)
It is assumed herein that N₁>N₂. And the pilot symbol is expressed as
P=[AABB] (25)
where P denotes the pilot symbol, A denotes N₁ samples, and B denotes N₂ samples.

Time synchronization is performed by

$$\tilde{T} = \frac{{\vert P ( d ) \vert}^{2}}{{( R ( d ) )}^{2}} \qquad ( 26 )$$

where \tilde{T} denotes estimated time synchronization, that is, an estimated symbol timing or frame timing. \tilde{T} that maximizes

$$\frac{{\vert P ( d ) \vert}^{2}}{{( R ( d ) )}^{2}}$$

in a corresponding accumulation period is detected as a symbol timing or a frame timing. The symbol timing indicates the start point of a symbol and the frame timing indicates the start point of a frame. Because the two different pilot sequences Aₚ and Bₚ each occur twice in one frame, the accumulation period is N₁ samples or N₂ samples.

In Equation (26),

$$P ( d ) = abs ( {\sum }_{k = 0}^{{N}_{1} - 1} {r}^{*} ( d + k ) r ( d + k + {N}_{1} ) ) + abs ( {\sum }_{k = 0}^{{N}_{2} - 1} {r}^{*} ( d + k + 2 {N}_{1} ) r ( d + k + {N}_{2} + 2 {N}_{1} ) )$$

$$R ( d ) = {\sum }_{k = 0}^{{N}_{1} - 1} {\vert r ( d + k + {N}_{1} ) \vert}^{2} + {\sum }_{k = 0}^{{N}_{2} - 1} {\vert r ( d + k + {N}_{2} + 2 {N}_{1} ) \vert}^{2} ,$$

and r(d) denotes a received signal. P(d) denotes an accumulation value of correlations between a (d+k)th sample and a (d+k+N₁)th sample in the accumulation period and an accumulation value of correlations between a (d+k)th sample and a (d+k+N₂)th sample in the accumulation period. R(d) is the average power of the accumulation period. In this manner, symbol timing and frame timing are detected, that is, symbol synchronization and frame synchronization are acquired. Frequency synchronization is acquired by the symbol synchronization and frame synchronization.

The frequency synchronization in the present invention will be described in more detail herein below.

Again the frequency offset is denoted by 6f and to acquire the frequency synchronization, the following relation is defined:

$${P}_{f} ( d ) = {\sum }_{k = 0}^{{N}_{2} - 1} {r}^{*} ( d + k + 2 {N}_{1} ) r ( d + k + {N}_{2} + 2 {N}_{1} ) \qquad ( 27 )$$

Assuming that a timing offset is accurately estimated in the time synchronization, that is, T is accurately estimated, P_{f}(T) is determined by

$$\begin{matrix}{P}_{f} ( T ) = {\sum }_{k = 0}^{{N}_{2} - 1} {r}^{*} ( T + k + 2 {N}_{1} ) r ( T + k + {N}_{2} + 2 {N}_{1} ) \\ = {\sum }_{k = 0}^{{N}_{2} - 1} {S}^{*} ( k + 2 {N}_{1} ) S ( k + {N}_{2} + 2 {N}_{1} ) exp ( j2π \cdot δ f \frac{{N}_{2}}{N \cdot Δ f} )\end{matrix} \qquad ( 28 )$$

where Δf is a sub-carrier spacing.

Under the same assumption, Equation (28) is developed to

$$< {P}_{f} ( T ) = 2 π \cdot δ f \cdot \frac{{N}_{2}}{N Δ f} \qquad ( 29 )$$

where |∠P_{f}(T)|<π is the phase of P_{f}(T). Therefore, the frequency offset can be estimated using Equation (29), expressed as

$$δ f = \frac{Δ f}{2 π} \frac{N}{{N}_{2}} < {P}_{1} ( T ) \qquad ( 30 )$$

Considering the 2π ambiguity of the phase, the condition that |∠P_{f}(T)|π must be satisfied. In the present invention, a frequency acquisition range for the frequency synchronization is

$$\vert δ f \vert = \frac{1}{2} \frac{N}{{N}_{2}} Δ f \qquad ( 31 )$$

As noted from Equation (31), the frequency acquisition range is widened in the present invention. Therefore, the frequency synchronization can be acquired accurately. For example, if N₂ is N/8 samples, the frequency acquisition range is increased to up to 4Δf, that is, four sub-carriers.

Although not shown, a pilot symbol transmitter has the same configuration as that in a conventional OFDM communication system. That is, the pilot signal transmitter comprises a pilot sequence generator for generating pilot sequences, a repeater for repeating the pilot sequences, and a transmitter for transmitting the repeated pilot sequences according to the pilot symbol structure.

In accordance with the present invention, a pilot sequence generator may generate the two pilot sequences AP and BP, or first and second pilot sequence generators may generate AP and BP, respectively. For notational simplicity, the latter case will be used by way of example.

The repeater repeats a predetermined number of times, that is, twice Ap and BP received from the first and second pilot sequence generators. The transmitter combines the repeated Aₚ and Bₚ to a pilot symbol and transmits it to a pilot signal receiver. Because the transmitter performs the same operation as during conventional RF (Radio Frequency) processing, a detailed description thereof will not be provided here.

FIG. 7 is a schematic block diagram of a pilot signal receiver to which the present invention is applied. Referring to FIG. 7, the pilot signal receiver comprises a time synchronization acquirer 711 and a frequency synchronization acquirer 713. Upon receipt of a pilot symbol signal, the time synchronization acquirer 711 acquires time synchronization in the manner described referring to FIG. 6 and outputs information about the resulting symbol timing and frame timing to the frequency synchronization acquirer 713. The frequency synchronization acquirer 713 operates in the manner described referring to FIG. 6. After synchronizing to the symbol timing and framing timing, the frequency synchronization acquirer 713 acquires frequency synchronization and outputs the resulting frequency offset. The frequency synchronization acquirer 713 acquires the frequency synchronization in the manner described referring to FIG. 6.

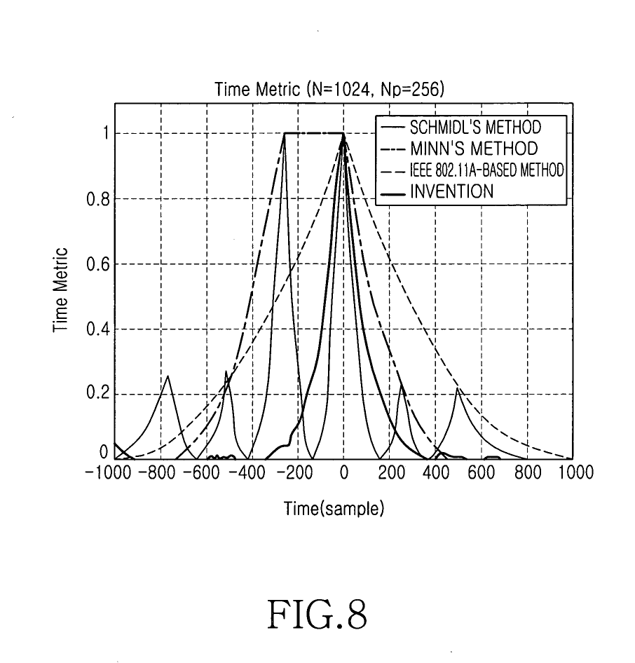

FIG. 8 is a graph illustrating time metrics in Schmidl's method, Minn's method, the IEEE 802.11a-based method, and a method of acquiring time synchronization and frequency synchronization according to the present invention, when the length of a cyclic prefix is 25% of an OFDM symbol length. Referring to FIG. 8, Minn's method cannot provide accurate time synchronization acquisition because it demonstrates two peak time metric values. Schmidl's method cannot provide accurate time synchronization acquisition either because it demonstrates as many peak time metric values as the cyclic prefix length.

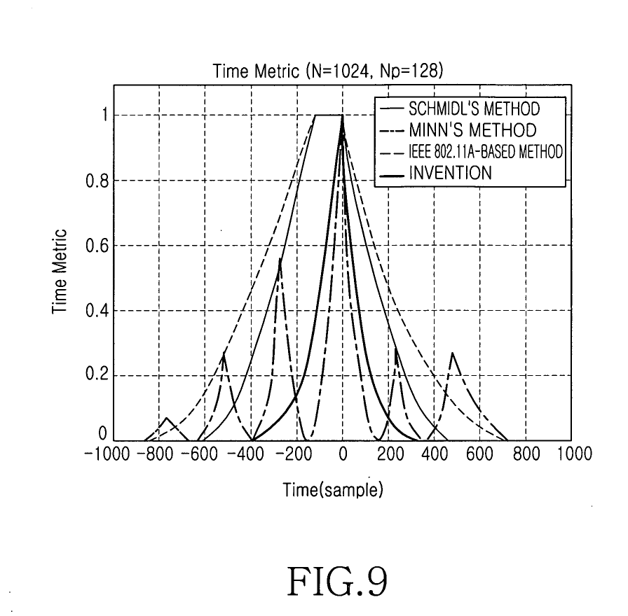

FIG. 9 is a graph illustrating time metrics in Schmidl's method, Minn's method, the IEEE 802.11a-based method, and the present invention, when the cyclic prefix length is 10% of the OFDM symbol length. Referring to FIG. 9, the IEEE 802.11a-based method and the Schmidl's method cannot provide accurate time synchronization acquisition because they demonstrate as many peak time metric values as the cyclic prefix length.

Table 1 below compares the performance of Schmidl's method, Minn's method, the IEEE 802.11a-based method, and the method of acquiring time synchronization and frequency synchronization according to the present invention.

TABLE 1
Channel characteristics

| Relative delay (ns) | Average power (dB) |
|---|---|
| 0 | 0 |
| 200 | −0.9 |
| 800 | −4.9 |
| 1200 | −8.0 |
| 2300 | −7.8 |
| 3700 | −23.9 |

The comparison is done under the condition that N=1024, N_{cp}=256, N₁=384, and N₂=128.

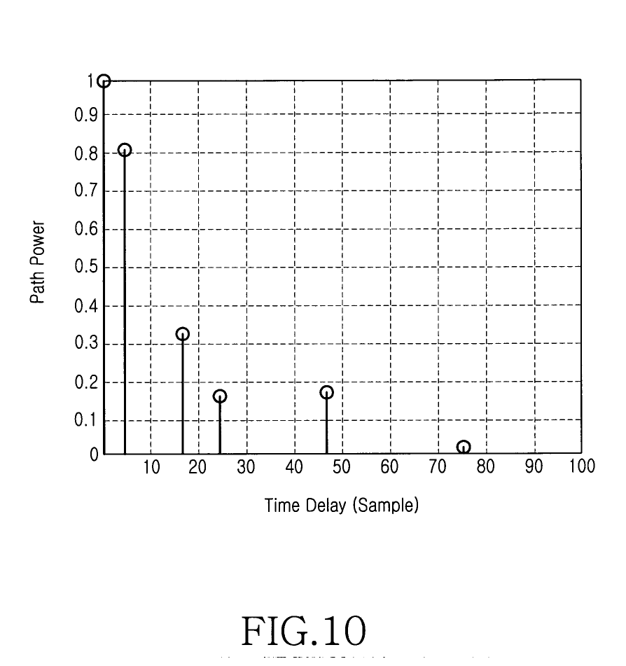

With reference to FIGS. 10 to 14, Schmidl's method, Minn's method, the IEEE 802.11a-based method, and the present invention will be compared in terms of the performance of time synchronization and frequency synchronization.

FIG. 10 is a graph illustrating mean channel power versus time delay. Referring to FIG. 10, mean channel power varies with time delay. Typically, the mean power is higher as the time delay is shorter.

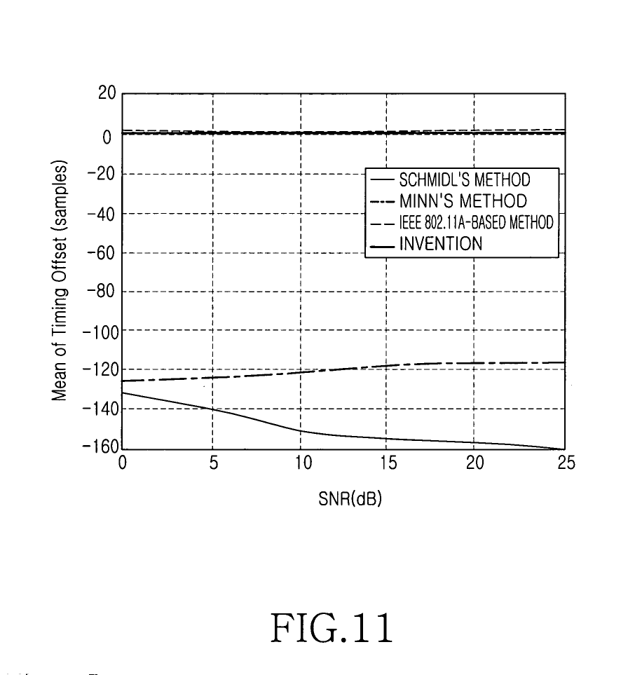

FIG. 11 is a graph illustrating the mean of an estimable symbol timing offset in Schmidl's method, Minn's method, the IEEE 802.11a-based method, and the present invention, when a frequency offset is 3Δf. Referring to FIG. 11, the mean of an estimated symbol timing offset becomes smaller in the order of Minn's method, Schmidl's method, the IEEE 802.11a-based method, and the present invention. Consequently, the IEEE 802.11a-based method and the present invention can acquire time synchronization most accurately.

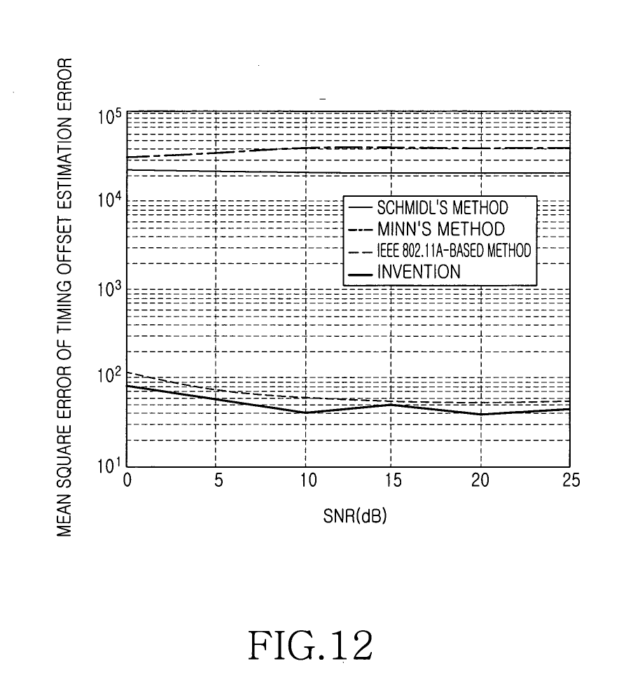

FIG. 12 is a graph illustrating the MSE of a symbol timing offset estimation error in Schmidl's method, Minn's method, the IEEE 802.11a-based method, and the present invention, when the frequency offset is 3Δf. Referring to FIG. 12, the MSE of a symbol timing offset estimation error becomes smaller in the order of Minn's method, Schmidl's method, the IEEE 802.11a-based method, and the present invention. Consequently, it is concluded that the present invention can acquire time synchronization most accurately.

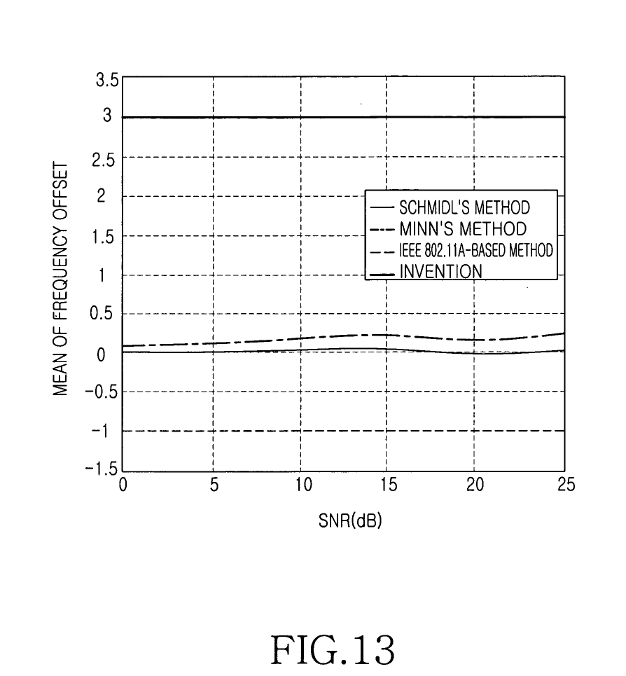

FIG. 13 is a graph illustrating the mean of an estimated frequency offset in Schmidl's method, Minn's method, the IEEE 802.11a-based method, and the present invention, when the frequency offset is 3Δf. Referring to FIG. 13, the mean of an estimated frequency offset becomes higher in the order of Schmidl's method, the IEEE 802.11a-based method, Minn's method, and the present invention. Consequently, it is concluded that the present invention acquires frequency synchronization most accurately.

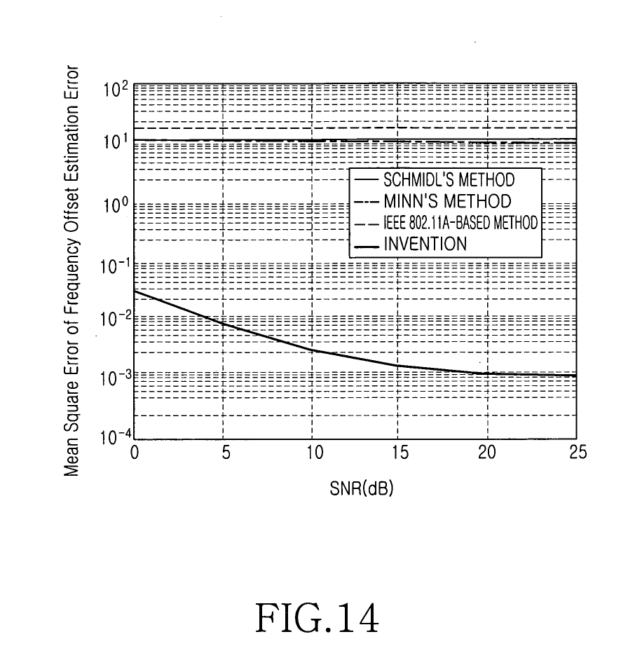

FIG. 14 is a graph illustrating the MSE of a frequency offset estimation error in Schmidl's method, Minn's method, the IEEE 802.11a-based method, and the present invention, when the frequency offset is 3Δf. Referring to FIG. 14, the MSE of a frequency offset estimation error becomes smaller in the order of Schmidl's method, the IEEE 802.11a-based method, Minn's method, and the present invention. Consequently, it is concluded that the present invention acquires frequency synchronization most accurately.

As described above, the present invention can acquire time synchronization and frequency synchronization most accurately when the frequency offset is 3Δf. A timing estimation error, that is, an error involved in time synchronization is one sample or less and a frequency offset estimation error is also very small in the present invention. While the IEEE 802.11a-based method offers accuracy in time synchronization due to a small timing estimation error, it leads to performance degradation in frequency synchronization. Both Schmidl's method and Minn's method experience performance degradation in time synchronization and frequency synchronization.

In accordance with the present invention, the structure of a pilot symbol having two sequences of different lengths repeated therein increases an estimable frequency offset, thereby enabling accurate frequency synchronization. Also, accurate symbol timing and frame timing can be acquired in timing synchronization.

While the present invention has been shown and described with reference to certain preferred embodiments thereof, it will be understood by those skilled in the art that various changes in form and details may be made therein without departing from the spirit and scope of the invention as defined by the appended claims.

1. A method of transmitting a pilot symbol for time synchronization and frequency synchronization in a multi-carrier modulation (MCM) communication system in which one frame includes at least one pilot symbol of a predetermined length and at least one data symbol of the predetermined length, comprising the steps of:
generating a first pilot sequence of a length shorter than the predetermined length;
generating a second pilot sequence of a length shorter than the predetermined length, the second pilot sequence being different from the first pilot sequence;
repeating the first and second pilot sequences a predetermined number of times; and
generating the pilot symbol by combining the repeated first and second pilot sequences and transmitting the pilot symbol.

2. The method of claim 1, wherein the lengths of the first and second sequences are different.

3. An apparatus for transmitting a pilot symbol for time synchronization and frequency synchronization in a multi-carrier modulation (MCM) communication system in which one frame includes at least one pilot symbol of a predetermined length and at least one data symbol of the predetermined length, comprising:
a pilot sequence generator for generating first and second pilot sequences, each having a length shorter than the predetermined length;
a repeater for repeating the first and second pilot sequences a predetermined number of times; and
a transmitter for generating the pilot symbol by combining the repeated first and second pilot sequences and transmitting the pilot symbol.

4. The apparatus of claim 3;, wherein the pilot sequence generator comprises:
a first pilot sequence generator for generating the first pilot sequence; and
a second pilot sequence generator for generating the second pilot sequence.

5. The apparatus of claim 3, wherein the lengths of the first and second pilot sequences are different.

6. An apparatus for receiving a pilot symbol for time synchronization and frequency synchronization in a multi-carrier modulation (MCM) communication system in which one frame includes at least one pilot symbol of a predetermined length and at least one data symbol of the predetermined length, comprising:
a time synchronization acquirer for receiving the pilot symbol having first and second pilot sequences repeated a predetermined number of times, each of the first and second pilot sequences having a length shorter than the predetermined length, and acquiring time synchronization with a transmitting apparatus; and
a frequency synchronization acquirer for receiving the pilot symbol, and acquiring frequency synchronization with the transmitting apparatus according to the time synchronization acquisition.

7. The apparatus of claim 6, wherein the time synchronization acquirer acquires the time synchronization at a time that maximizes a quotient of dividing an absolute value of a sum of correlations of the first pilot sequences and the correlations of the second pilot sequences in a predetermined accumulation period by an average power in the predetermined accumulation period.

8. The apparatus of claim 7, wherein the average power in the predetermined accumulation period is a sum of an average power of the first pilot sequences and an average power of the second pilot sequences in the predetermined accumulation period.

9. The apparatus of claim 6, wherein the frequency synchronization acquirer acquires the frequency synchronization using a phase of a sum of correlations of the first pilot sequences and correlations of the second pilot sequences in a predetermined accumulation period at the time synchronization acquisition time.

10. An apparatus for receiving a pilot symbol for time synchronization and frequency synchronization in a multi-carrier modulation (MCM) communication system in which N sub-carriers are used, N sub-carrier signals form a symbol, and one frame includes at least one pilot symbol of a predetermined length and at least one data symbol of the predetermined length, comprising:
a time synchronization acquirer for receiving a pilot symbol including first and second pilot sequences repeated a predetermined number of times, each of the first and second pilot sequences having a length shorter than the predetermined length, and acquiring time synchronization with a transmitting apparatus; and
a frequency synchronization acquirer for receiving the pilot symbol, and acquiring frequency synchronization with the transmitting apparatus according to the time synchronization acquisition.

11. The apparatus of claim 10, wherein the time synchronization acquirer acquires the time synchronization using
$$\tilde{T} = \frac{{\vert P ( d ) \vert}^{2}}{{( R ( d ) )}^{2}}$$
where \tilde{T} denotes a time at which estimated time synchronization is acquired,
$$P ( d ) = abs ( {\sum }_{k = 0}^{{N}_{1} - 1} {r}^{*} ( d + k ) r ( d + k + {N}_{1} ) ) + abs ( {\sum }_{k = 0}^{{N}_{2} - 1} {r}^{*} ( d + k + 2 {N}_{1} ) r ( d + k + {N}_{2} + 2 {N}_{1} ) ) , \\ R ( d ) = {\sum }_{k = 0}^{{N}_{1} - 1} {\vert r ( d + k + {N}_{1} ) \vert}^{2} + {\sum }_{k = 0}^{{N}_{2} - 1} {\vert r ( d + k + {N}_{2} + 2 {N}_{1} ) \vert}^{2} ,$$
r(d) denotes a received signal, P(d) denotes an accumulation value of correlations between a (d+k)th sample and a (d+k+N₁)th sample in a predetermined accumulation period and an accumulation value of correlations between a (d+k)th sample and a (d+k+N₂)th sample in the accumulation period, R(d) is an average power of the accumulation period, N₁ is the length of the first pilot sequence, and N₂ is the length of the second pilot sequence.

12. The apparatus of claim 11, wherein the frequency synchronization acquirer acquires the frequency synchronization using
$$∠ {P}_{f} ( T ) = 2 π \cdot δ f \cdot \frac{{N}_{2}}{N Δ f}$$
where ∠P_{f}(T) is a phase of P_{f}(T), which is an accumulation value of correlations between a (T+k)th sample and a (T+k+N₁)th sample in a predetermined accumulation period and an accumulation value of correlations between a (T+k)th sample and a (T+k+N₂)th sample in the accumulation period.

13. A method of receiving a pilot symbol for time synchronization and frequency synchronization in a multi-carrier modulation (MCM) communication system in which one frame includes at least one pilot symbol of a predetermined length and at least one data symbol of the predetermined length, comprising the steps of:
receiving the pilot symbol including first and second pilot sequences repeated a predetermined number of times, each of the first and second pilot sequences having a length shorter than the predetermined length;
acquiring time synchronization with a transmitting apparatus; and
acquiring frequency synchronization with the transmitting apparatus according to the time synchronization acquisition.

14. The method of claim 13, wherein the time synchronization acquisition is acquired at a time that maximizes a quotient of dividing an absolute value of a sum of correlations of the first pilot sequences and correlations of the second pilot sequences in a predetermined accumulation period by an average power in a predetermined accumulation period.

15. The method of claim 14, wherein the average power in the predetermined accumulation period is a sum of an average power of the first pilot sequences and an average power of the second pilot sequences in the predetermined accumulation period.

16. The method of claim 13, wherein the frequency synchronization acquisition is acquired using a phase of a sum of correlations of the first pilot sequences and correlations of the second pilot sequences in a predetermined accumulation period at the time synchronization acquisition time.

17. A method of receiving a pilot symbol for time synchronization and frequency synchronization in a multi-carrier modulation (MCM) communication system in which N sub-carriers are used, N sub-carrier signals form a symbol, and one frame includes at least one pilot symbol of a predetermined length and at least one data symbol of the predetermined length, comprising the steps of:
receiving a pilot symbol including first and second pilot sequences repeated a predetermined number of times, each of the first and second pilot sequences having a length shorter than the predetermined length;
acquiring time synchronization with a transmitting apparatus; and
acquiring frequency synchronization with the transmitting apparatus according to the time synchronization acquisition.

18. The method of claim 17, wherein the time synchronization is acquired using
$$\tilde{T} = \frac{{\vert P ( d ) \vert}^{2}}{{( R ( d ) )}^{2}}$$
where \tilde{T} denotes a time at which estimated time synchronization is acquired,
$$P ( d ) = abs ( {\sum }_{k = 0}^{{N}_{1} - 1} {r}^{*} ( d + k ) r ( d + k + {N}_{1} ) ) + abs ( {\sum }_{k = 0}^{{N}_{2} - 1} {r}^{*} ( d + k + 2 {N}_{1} ) r ( d + k + {N}_{2} + 2 {N}_{1} ) ) , \\ R ( d ) = {\sum }_{k = 0}^{{N}_{1} - 1} {\vert r ( d + k + {N}_{1} ) \vert}^{2} + {\sum }_{k = 0}^{{N}_{2} - 1} {\vert r ( d + k + {N}_{2} + 2 {N}_{1} ) \vert}^{2} ,$$
r(d) denotes a received signal, P(d) denotes an accumulation value of correlations between a (d+k)th sample and a (d+k+N₁)th sample in a predetermined accumulation period and an accumulation value of correlations between a (d+k)th sample and a (d+k+N₂)th sample in the accumulation period, R(d) is an average power of an accumulation period, N₁ is the length of the first pilot sequence, and N₂ is the length of the second pilot sequence.

19. The method of claim 17, wherein the frequency synchronization is acquired using
$$∠ {P}_{f} ( T ) = 2 π \cdot δ f \cdot \frac{{N}_{2}}{N Δ f}$$
where ∠P_{f}(T) is a phase of P_{f}(T), which is an accumulation value of correlations between a (T+k)th sample and a (T+k+N₁)th sample in a predetermined accumulation period and an accumulation value of correlations between a (T+k)th sample and a (T+k+N₂)th sample in the accumulation period.
